(19) United States
(12) Patent Application Publication
(10) Pub. No.: US 2019/0180221 A1
(43) Pub. Date: Jun. 13, 2019

(54) TRANSMITTING AN INVENTORY-BASED NOTIFICATION TO A MOBILE DEVICE

(71) Applicant: International Business Machines Corporation, Armonk, NY (US)

(72) Inventors: Jeremy A. Greenberger, San Jose, CA (US); Zachary M. Greenberger, Raleigh, NC (US); Jana H. Jenkins, Raleigh, NC (US)

(21) Appl. No.: 15/834,358

(22) Filed: Dec. 7, 2017

(51) Int. Cl. G06Q 10/08; G06Q 30/02; H04W 4/12

(52) U.S. Cl. CPC G06Q 10/087; G06Q 30/0267; H04W 4/023; G06Q 30/0261; H04W 4/12; G06Q 30/0255

(57) ABSTRACT

Approaches presented herein enable transmitting an inventory-based notification to a mobile device of a consumer. A product of interest to the consumer is identified, either based on purchasing history or explicitly selected by the consumer. Based on an inventory status of the product of interest, an inventory event is detected (e.g., expected depletion of inventory, expected replenishment of inventory, etc.). A location of the mobile device of the consumer is determined relative to one or more nearby retail locations. An alert is automatically transmitted to the mobile device based on the inventory event and the location of the user relative to the retail location(s).

### TECHNICAL FIELD

The subject matter of this invention relates generally to location-based services. More specifically, aspects of the present invention provide a solution for transmitting an inventory-based notification to a mobile device of a user based on an inventory event of a product of interest to the user and a location of the user relative to one or more nearby retail locations.

### BACKGROUND

As mobile devices become increasingly more common, more companies are engaging in mobile marketing. Mobile marketing encompasses all those activities which connect advertisers to consumers through mobile devices and networks. Because the mobile device (e.g., smartphone or tablet) is increasingly becoming the vehicle of communication and online interaction for countless consumers worldwide, many companies have turned to mobile marketing, sending advertisements straight to mobile devices, often in the form of a text message.

Mobile marketing is an extension of Internet marketing, and, as such, is dependent largely on a form of permission-based marketing. In order to actively market to a mobile device, a company must first obtain user information (e.g., the user's phone number), which can generally only be accomplished by requesting it as part of delivering a service or by promising rewards to subscribers. A consumer typically must first opt in to receiving messages in order to begin receiving communications from a company. Many companies use mobile marketing as a way to engage audiences, asking questions or giving alerts about upcoming events. Whether a company has upcoming deals, daily coupons or new products, direct digital messaging proves to be an option for informing consumers.

### SUMMARY

In general, embodiments of the present invention enable transmitting an inventory-based notification to a mobile device of a consumer. A product of interest to the consumer is identified, either based on purchasing history or explicitly selected by the consumer. Based on an inventory status of the product of interest, an inventory event is detected (e.g., expected depletion of inventory, expected replenishment of inventory, etc.). A location of the mobile device of the consumer is determined relative to one or more nearby retail locations. An alert is automatically transmitted to the mobile device based on the inventory event and the location of the user relative to the retail location(s).

One aspect of the present invention includes a method for transmitting an inventory-based notification to a mobile device of a consumer, the method comprising: identifying a product of interest to the user; calculating a time at which an inventory of the product is expected to be exhausted at a retail location nearby a current location of the user; and automatically transmitting an alert to the mobile device informing the user of an expected inventory exhaustion in response to an estimated travel time of the user to the retail location, wherein the estimated travel time is prior to the time of the expected inventory exhaustion.

Another aspect of the present invention includes a computer program product embodied in a computer readable medium that, when executed by a computer device, performs a method for transmitting an inventory-based notification to a mobile device of a consumer, the method comprising: identifying a product of interest to the user; calculating a time at which an inventory of the product is expected to be exhausted at a retail location nearby a current location of the user; and automatically transmitting an alert to the mobile device informing the user of an expected inventory exhaustion in response to an estimated travel time of the user to the retail location, wherein the estimated travel time is prior to the time of the expected inventory exhaustion.

Yet another aspect of the present invention includes a system for transmitting an inventory-based notification to a mobile device of a consumer, comprising: a memory medium comprising instructions; a bus coupled to the memory medium; and a processor coupled to the bus that when executing the instructions causes the system to perform a method, comprising: identifying a product of interest to the user; calculating a time at which an inventory of the product is expected to be exhausted at a retail location nearby a current location of the user; and automatically transmitting an alert to the mobile device informing the user of an expected inventory exhaustion in response to an estimated travel time of the user to the retail location, wherein the estimated travel time is prior to the time of the expected inventory exhaustion.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture 10 in which the invention may be implemented according to an illustrative embodiment of the present invention;

FIG. 2 shows a first schematic diagram 200 illustrating an exemplary environment for implementation according to an illustrative embodiment of the present invention;

FIG. 3 shows an example product page 300 related to a product of interest to a consumer according to an illustrative embodiment of the present invention;

FIG. 4 shows an example notification 400 according to an illustrative embodiment of the present invention; and

FIG. 5 shows a process flowchart 500 for transmitting an inventory-based notification based on an inventory event of a product of interest to a consumer and a location of the consumer relative to one or more nearby retail locations according to an illustrative embodiment of the present invention.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing”, “detecting”, “determining”, “evaluating”, “receiving”, or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission, or viewing devices. The embodiments are not limited in this context. As used herein, the terms “user” and “consumer” are used interchangeably and refer to an individual who has opted in to receiving local inventory notifications.

As stated above, embodiments of the present invention enable transmitting an inventory-based notification to a mobile device of a consumer. A product of interest to the consumer is identified, either based on purchasing history or explicitly selected by the consumer. Based on an inventory status of the product of interest, an inventory event is detected (e.g., low inventory, arriving inventory, etc.). A location of the mobile device of the consumer is determined relative to one or more nearby retail locations. An alert is automatically transmitted to the mobile device based on the inventory event and the location of the user relative to the retail location(s).

Mobile marketing is a term that can encompass any promotional activity that takes place on a smartphone or other mobile device. This type of marketing has proven to be an effective method for informing consumers of upcoming deals, daily coupons, new products, and/or the like. However, the inventors of the invention described herein have recognized certain deficiencies in known methods for transmitting an inventory-based notification to a mobile device of a user in many common mobile marketing scenarios. While these scenarios are sometimes based on a location of a consumer, such as nearby one or more nearby retail locations, they do not also take into account a consumer's specific interest in a product and an inventory status of that product. A retailer would not want a consumer to go to a retail location looking for a particular product only to find out that the product has recently sold out.

Using only location information without regard to a user's interest in a given product and an inventory status of that product may diminish the very power of using location data in mobile marketing. By using the methods described herein for presenting notifications to consumers having a mobile device, a retailer can better serve them by employing a more targeted messaging strategy. The approaches described herein provide a seamless way for transmitting an inventory-based notification to a mobile device of a user based on an inventory event of a product of interest to the user and a location of the user relative to one or more nearby retail locations.

In certain embodiments, an advantage of this approach is its reduction of computing overhead. Computing overhead is generally considered any combination of excess or indirect computation time, memory, bandwidth, or other resources that are required to attain a particular goal. By optimizing the presentation of notifications by only presenting notifications based on a user's level of interest, item inventory status, and current user location, the computing overhead is reduced by employing a more targeted messaging approach. Also, by reducing consumption of computing resources, this approach increases the number of users (i.e., system capacity) that can be accommodated. Further, the optimization of presenting notifications to a user's mobile device impacts the consumption of resources on the mobile device itself, since the notifications are specifically targeted to the particular user.

This approach also improves the fundamental operation of the system as a whole. A retailer sending an abundance of notifications to a consumer regarding an item that the consumer has no interest in or is not in inventory may affect the reputation of the retailer by increasing negative sentiment toward the retailer. However, by only transmitting an inventory-based notification to the user based on an item of interest to the user, an inventory status, and a location of the user, this approach provides optimal throughput of consumers to the retail location while reducing the likelihood of generating negative sentiment.

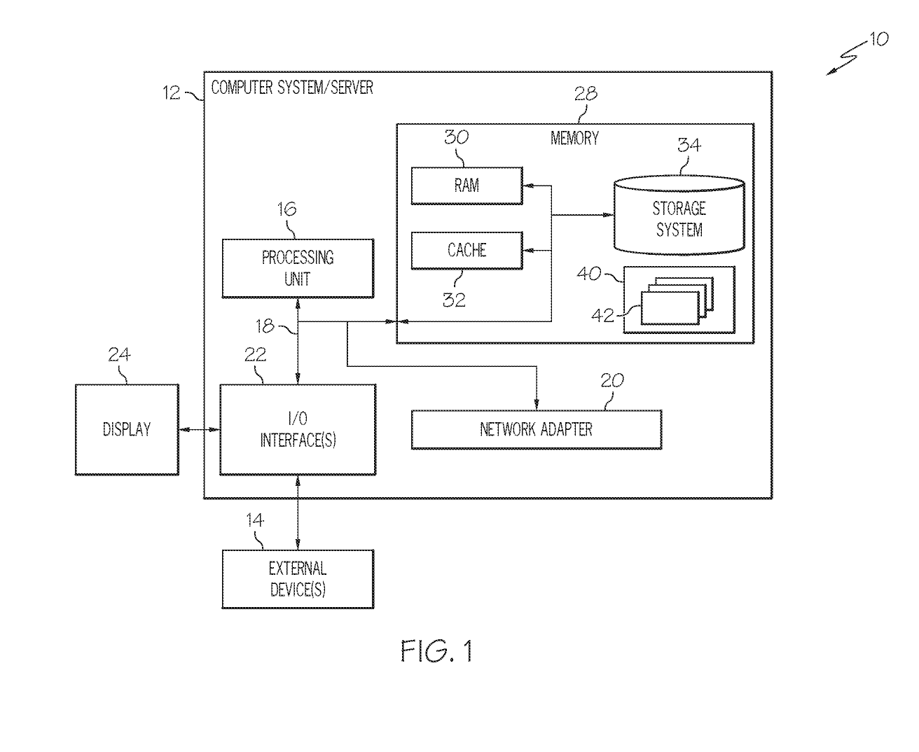

Referring now to FIG. 1, a computerized implementation 10 of an embodiment for transmitting an inventory-based notification to a mobile device of a user based on an inventory event of a product of interest to the user and a location of the user relative to one or more nearby retail locations will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for transmitting an inventory-based notification to a mobile device of a user based on an inventory event of a product of interest to the user and a location of the user relative to one or more nearby retail locations. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for transmitting an inventory-based notification to a mobile device of a user based on an inventory event of a product of interest to the user and a location of the user relative to one or more nearby retail locations, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

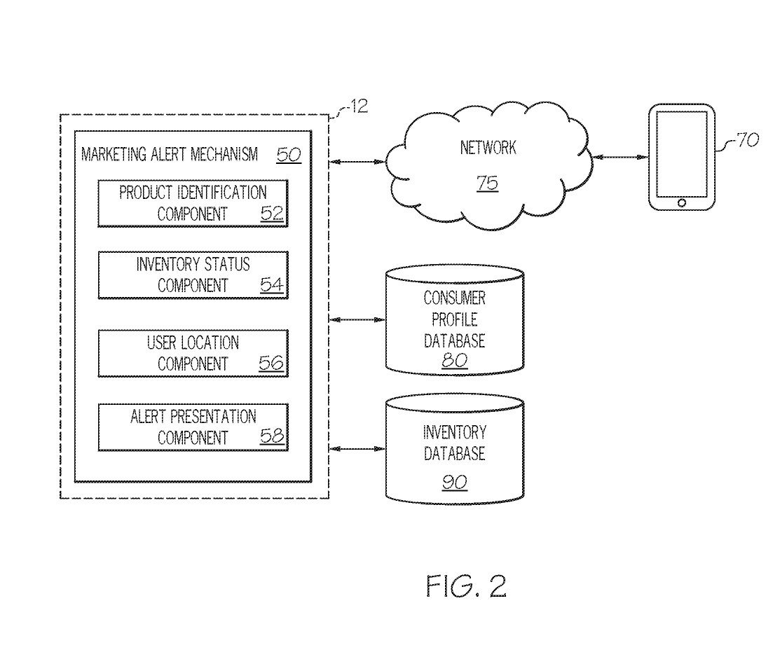

Referring now to FIG. 2, a block diagram 200 describing the functionality discussed herein according to an embodiment of the present invention is shown. It is understood that the teachings recited herein may be practiced within any type of computing environment (e.g., computer system 12). To this extent, the teachings recited herein may be practiced within a stand-alone computer system or within a networked computing environment (e.g., a client-server environment, peer-to-peer environment, distributed computing environment, cloud computing environment, and/or the like). If the teachings recited herein are practiced within a networked computing environment, each physical server need not have a marketing alert mechanism 50 (hereinafter “system 50”). Rather, system 50 could be loaded on a server or server-capable device that communicates (e.g., wirelessly) with the physical server to transmit an alert to a mobile device of a user based on an inventory event of a product of interest to the user and a location of the user relative to one or more nearby retail locations.

Regardless, as depicted, system 50 can be implemented as program/utility 40 on computer system 12 of FIG. 1 and can enable the functions recited herein. It is further understood that system 50 can be incorporated within or work in conjunction with any type of system that receives, processes, and/or executes commands with respect to IT resources in a networked computing environment. Such other system(s) have not been shown in FIG. 2 for brevity purposes. As shown, marketing alert mechanism 50 includes product identification component 52, inventory status component 54, user location component 56, and alert presentation component 58. The functions/acts of each component is described in detail below.

As shown, marketing alert mechanism 50 may be communicatively coupled with mobile device 70 via a network 75. The network 75 may be any type of network or any combination of networks. Specifically, the network 75 may include wired components, wireless components, or both wired and wireless components. Mobile device 70 may be a mobile smart phone, portable media player device, portable fitness device, mobile gaming device, laptop computer, tablet, or the like. Some exemplary devices that may be programmed or otherwise configured to operate as mobile device 70 are the Apple® iPhone®, the Motorola Droid or similar smart phone running Google's Android™ Operating System, an Apple® iPad™, and the Apple® iPod Touch® device. However, this list of exemplary devices is not exhaustive and is not intended to limit the scope of the present disclosure.

Further, marketing alert mechanism 50 may be communicatively coupled with consumer profile database 80 and/or inventory database 90. User profile database 80 may include a consumer's name, address, one or more registered mobile devices, phone number(s), email address(es), purchasing history including dates and/or times of purchases, a list of products of interest to the consumer, and/or the like. Inventory database 90 may be used for storing and administering all types of data required for efficient and accurate warehouse inventory management. This may include modules or fields for keeping track of all items and locations, requisitions, back orders, required levels of inventory on hand, reorder points, lead times, inventory error tracking, and/or the like. User profile database 80 and/or inventory database 90 may include a relational database, which can be implemented in a combination of hardware (i.e., physical data storage hardware) and software (i.e., relational database software).

Product identification component 52 of system 50, as executed by computer system/server 12, is configured to identify one or more products of interest for a consumer/user who has opted in to receiving local inventory notifications on mobile device 70. As used herein, the term “product” includes any good or service offered for sale at a one or more nearby retail locations by a retailer. In an embodiment, one or more products of interest may be derived based on the consumer's purchasing history. To that end, product identification component 52 may be configured to identify one or more products of interest to a consumer based on a purchase history of the consumer. For example, a product may be identified as one of interest to a consumer if the consumer purchases that product at least a predefined number of times within a predefined time period (e.g., at least once a month).

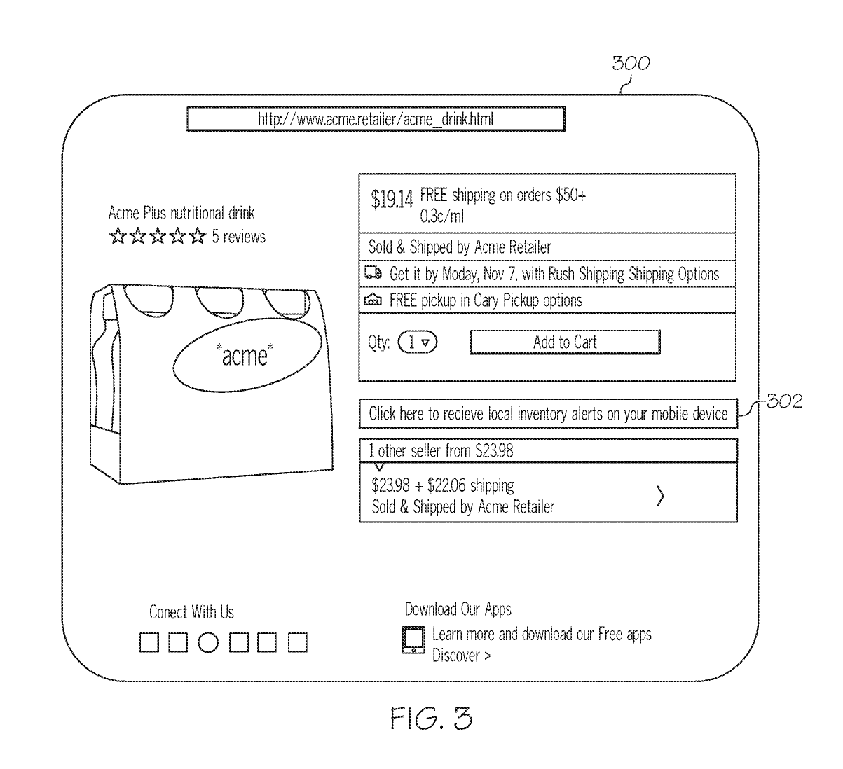

In another example, a consumer may explicitly specify one or more products for which he/she wishes to receive local inventory notifications. FIG. 3 shows an example web page including product page 300 for ‘Acme Plus nutritional drink’. As shown, product page 300 includes product information along with alert option 302. A consumer may click or otherwise select alert option 302 to begin receiving local inventory alerts on a mobile device for the product. The methods listed above for identifying a product of interest is illustrative only and not intended to be limiting. In an embodiment, a consumer may also be provided an option to stop receiving all notifications or notifications for one or more specified products. For example, a consumer may communicate his/her preferences to a retailer via an email message, text message, phone call, and/or an option provided on the retailer's website.

Inventory status component 54 of system 50, as executed by computer system/server 12, is configured to monitor an inventory status for each identified product of interest to detect any number of predefined inventory events, such as a reduction of inventory below a predefined threshold, an upcoming replenishment of inventory, an estimated sell-out time of a product within a predefined time window, and/or the like. For example, inventory status component 54 may determine when an inventory of a product of interest falls below a predefined threshold (e.g., less than 10 units remaining for sale). A consumer planning to frequent a nearby retailer to purchase a particular product may visit the retailer sooner if he/she is made aware of the low inventory so as to ensure a purchase of the product. In an embodiment, system may monitor inventory of one or more nearby retail locations nearby to the consumer. For example, a user may have 3 Acme Store retail locations within 10 miles of his/her location. In that case, an inventory of a particular product at each individual location may be monitored for this process.

In another example, inventory status component 54 may predict an estimated time that a product of interest is likely to sell out within a predefined time window (e.g., within the next 6 hours) at a nearby retailer based on its current sale rate. A hot-selling product may be “flying off the shelves” and may quickly become unavailable for purchase. For example, assume a product with a current inventory of 50 units is selling at a rate of 10 units per hour. In that instance, a predicted sell-out time can be estimated at approximately five hours. A consumer may enjoy receiving a notification/alert that the particular product is selling quickly and that the consumer may want to stop into the nearby retailer soon and purchase the product before it sells out.

In still another example, inventory status component 54 may be configured to determine when a product of interest will be arriving within a predefined time window (e.g., at beginning of next business day) at one or more nearby retail locations, either for a first time or to replenish inventory. A consumer may wish to be notified when a product that is highly anticipated by the consumer will be in inventory at a nearby retailer so that the consumer can stop into the retailer to purchase the product as soon as possible. In any case, inventory status component 54 monitors an inventory status for each identified product of interest to identify whether a predefined inventory event has occurred which might necessitate transmitting an inventory-based notification to a consumer. The inventory events listed above are exemplary only and not intended to be limiting. Additional and/or alternative inventory events may be established by a retailer.

User location component 56 of system 50, as executed by computer system/server 12, is configured to determine a location of a mobile device 70 associated with a consumer relative to one or more nearby retail locations. In an embodiment, a location of a consumer having a mobile device 70 may be determined as the consumer enters an established geo-fence. Geo-fencing uses global positioning satellite (GPS) coordinates to encapsulate a geographic area and takes a mobile device user's (who has opted in to receive push notifications via a mobile device) location data via GPS to determine his/her proximity to that particular region (whether the person is inside or outside, or just went in or came out of that particular area, in a matter of seconds). A typical function of geo-fencing is to allow retailers to send notifications to mobile device users when the users enter a defined geographic area, such as nearby a retail location, etc. Part of this technology involves setting a transmittal range for who will receive these notifications. In another embodiment, a location of a consumer having a mobile device 70 may be determined using one or more now known (e.g., Bluetooth Low Energy (BLE) beacons, Wi-Fi triangulation, etc.) or later developed techniques. In any event, user location component 56 determines a location of a mobile device 70 associated with a consumer relative to one or more nearby retail locations (i.e., a distance the consumer is from a particular retail location).

In another embodiment, a location of a consumer may be detected without regard to mobile device 70. For example, one or more cameras may detect whether the consumer has entered or nearby a retail location. A calendar application related to the consumer may be checked to determine if a location of the consumer can be ascertained. For example, the consumer may have a calendar entry specifying the consumer is attending a birthday party at a certain time at a particular location. The location may be nearby a retail location having one or more products of interest to the consumer.

Alert presentation component 58 of system 50, as executed by computer system/server 12, is configured to automatically transmit an alert to mobile device 70 based on an inventory event of a product of interest to a consumer and a location of the consumer relative to one or more nearby retail locations. In an embodiment, an alert may be transmitted to mobile device 70 via text message, email message, push notification, and/or the like. The phone number, email message, and/or other consumer contact information may be ascertained by a retailer during an opt-in or registration process. Having this information can allow a retailer to communicate messages to the consumer. For example, an alert may be sent to mobile device 70 using a phone number provided by the consumer. In another embodiment, a consumer may download and install a mobile application (or “app”) to which push notifications can be sent to the consumer. In any case, alert presentation component 58 automatically transmits an alert to mobile device 70 for a product of interest to a consumer based on an inventory event and a location of the consumer relative to one or more nearby retail locations.

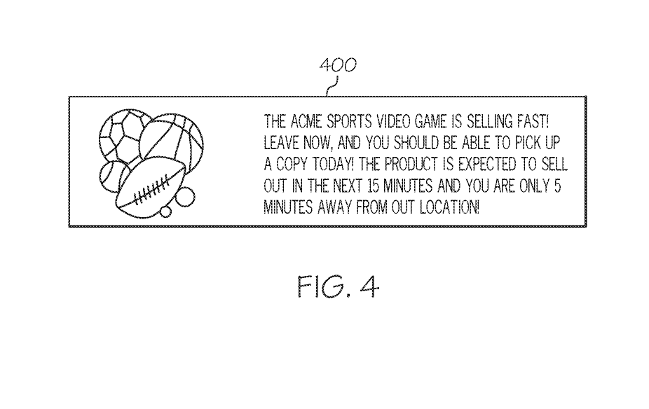

In an embodiment, an alert may be transmitted to mobile device 70 for a product of interest to a consumer when the consumer is within a predefined distance threshold (e.g., five miles) to a participating retail location having the product and an inventory event has occurred (e.g., inventory likely to run out shortly, product selling quickly, product inventory has just arrived and likely to be in high demand with limited availability, etc.). FIG. 4 shows an example notification (e.g., text message) displayed on mobile device 70. As shown, system 50 has predicted ACME Sports video game might sell out soon and has determined that the consumer is within five miles of the retail location. Therefore, an alert is sent to mobile device 70 to let the consumer know that if he/she hurries, a purchase of the product can likely be made. Conversely, a consumer likely would not wish to be notified of the inventory event if the nearest retail location is 1,000 miles away from the consumer's current location.

In another embodiment, an alert may be transmitted to mobile device 70 based on an inventory event and a predefined travel time and/or arrival time to a retail location based on the consumer's current location. For example, if an inventory event has occurred related to a product of interest to the consumer, an alert can be transmitted to mobile device 70 if the consumer's estimated travel time to the retail location is below a predefined amount of time (e.g., 30 minutes). A consumer likely would not wish to be notified of the inventory event if the estimated travel time to the retail location is several hours. In an embodiment, a travel time and/or distance threshold may be configured by a user. Similarly, the consumer likely would not want to be alerted if an estimated arrival time at the retail location is after the estimated sell-out time of the product. For example, if a product is likely to sell out in 15 minutes and the estimated arrival time is 10 minutes later, an alert will not be transmitted to mobile device 80. Optionally, a minimum amount of travel time for a consumer to get to the retail location may be defined (e.g., 15 minutes) in an attempt to avoid sending an alert to the consumer only to have the consumer arrive with the product having sold out only moments earlier.

Alternatively or in addition, alert presentation component 58 may be further configured to transmit an alert to a consumer only during a derived time window based on a purchasing history of the consumer. For example, assume a consumer purchases chicken soup every weekday at lunch time (e.g., between 11 a.m. and 1 p.m.) at a nearby restaurant location. Based on the consumer's purchasing history, further assume that the consumer rarely visits the retail location outside that time window and, when she does, purchases something other than chicken soup. Based on this information, it can be assumed that the consumer would not care to be notified that there is no more chicken soup available for sale at 3 p.m. on a given weekday or on the weekend. However, the consumer likely would want to be notified on a Monday at 10:55 a.m. that her chicken soup will not be available. Therefore, alert presentation component 58 may further be configured to transmit an alert to mobile device 70 during a derived time window based on the consumer's purchasing history along with a location of the consumer.

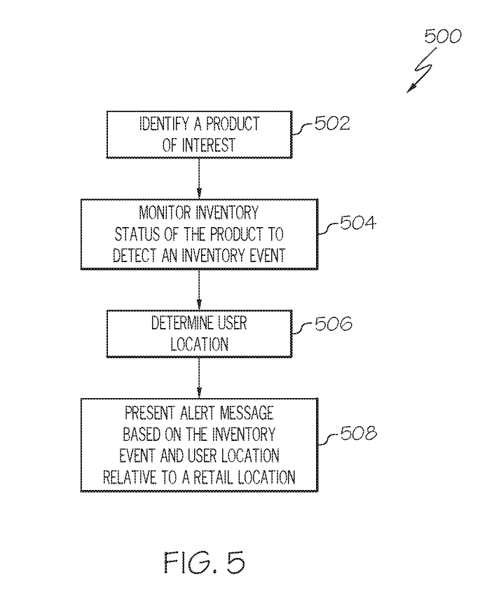

Referring now to FIG. 5, in conjunction with FIG. 2, an implementation of a process flowchart 500 for transmitting an inventory-based notification to a mobile device of a user based on an inventory event of a product of interest to the user and a location of the user relative to one or more nearby retail locations is shown. At step 502, product identification component 52 identifies a product of interest to a consumer. At step 504, inventory status component 54 monitors an inventory status for the product of interest to detect an inventory event. At step 506, user location component 56 determines a current location of the consumer. At step 508, alert presentation component 58 transmits an alert to mobile device 70 based on the inventory event (e.g., inventory below predefined threshold, new inventory, etc.) and the location of the user (e.g., nearby the retail location).

Process flowchart 600 of FIG. 6 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the Figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for transmitting an inventory-based notification to a mobile device of a user based on an inventory event of a product of interest to the user and a location of the user relative to one or more nearby retail locations. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for transmitting an inventory-based notification to a mobile device of a user based on an inventory event of a product of interest to the user and a location of the user relative to one or more nearby retail locations. In this case, the service provider can create, maintain, support, etc., a computer infrastructure that performs the process steps of the invention for one or more consumers. In return, the service provider can receive payment from the consumer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (for example, the Internet, a local area network, a wide area network and/or a wireless network). The network may comprise copper transmission cables, optical transmission fibers, wireless transmission, routers, firewalls, switches, gateway computers and/or edge servers. A network adapter card or network interface in each computing/processing device receives computer readable program instructions from the network and routes the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an document of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

It is apparent that there has been provided herein approaches for transmitting an inventory-based notification to a mobile device of a user based on an inventory event of a product of interest to the user and a location of the user relative to one or more nearby retail locations. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for transmitting an inventory-based notification to a mobile device of a user, the method comprising:
identifying a product of interest to the user;
calculating a time at which an inventory of the product is expected to be exhausted at a retail location nearby a current location of the user; and
automatically transmitting an alert to the mobile device informing the user of an expected inventory exhaustion in response to an estimated travel time of the user to the retail location, wherein the estimated travel time is prior to the time of the expected inventory exhaustion.

2. The method of claim 1, wherein the identifying of the product of interest is based on a purchasing history of the consumer.

3. The method of claim 1, further comprising calculating an estimated travel time based on a location of the user relative to the retail location.

4. The method of claim 1, further comprising calculating a time at which an inventory of the product is expected to be replenished at the retail location.

5. The method of claim 4, further comprising automatically transmitting an alert to the mobile device informing the user of the expected inventory replenishment in response to an estimated travel time of the user to the retail location, wherein the estimated travel time is greater than the time of the expected inventory replenishment.

6. The method of claim 1, further comprising transmitting the alert when a distance between the location of the user and the retail location is below a predefined threshold.

7. The method of claim 1, further comprising transmitting the alert during a time window, wherein the time window is derived from a purchasing history of the product.

8. A computer program product embodied in a computer readable medium that, when executed by a computer device, performs a method for transmitting an inventory-based notification to a mobile device of a consumer, the method comprising:
identifying a product of interest to the user;
calculating a time at which an inventory of the product is expected to be exhausted at a retail location nearby a current location of the user; and
automatically transmitting an alert to the mobile device informing the user of an expected inventory exhaustion in response to an estimated travel time of the user to the retail location, wherein the estimated travel time is prior to the time of the expected inventory exhaustion.

9. The computer program product of claim 8, wherein the identifying of the product of interest is based on a purchasing history of the consumer.

10. The computer program product of claim 8, the method further comprising calculating an estimated travel time based on a location of the user relative to the retail location.

11. The computer program product of claim 8, the method further comprising calculating a time at which an inventory of the product is expected to be replenished at the retail location.

12. The computer program product of claim 11, the method further comprising automatically transmitting an alert to the mobile device informing the user of the expected inventory replenishment in response to an estimated travel time of the user to the retail location, wherein the estimated travel time is greater than the time of the expected inventory replenishment.

13. The computer program product of claim 8, the method further comprising transmitting the alert when a distance between the location of the user and the retail location is below a predefined threshold.

14. The computer program product of claim 8, the method further comprising transmitting the alert during a time window, wherein the time window is derived from a purchasing history of the product.

15. A system for transmitting an inventory-based notification to a mobile device of a consumer, comprising:
a memory medium comprising instructions;
a bus coupled to the memory medium; and
a processor coupled to the bus that when executing the instructions causes the system to perform a method, comprising:
identifying a product of interest to the user;
calculating a time at which an inventory of the product is expected to be exhausted at a retail location nearby a current location of the user; and
automatically transmitting an alert to the mobile device informing the user of an expected inventory exhaustion in response to an estimated travel time of the user to the retail location, wherein the estimated travel time is prior to the time of the expected inventory exhaustion.

16. The system of claim 15, wherein the identifying of the product of interest is based on a purchasing history of the consumer.

17. The system of claim 15, the method further comprising further comprising calculating an estimated travel time based on a location of the user relative to the retail location.

18. The system of claim 15, the method further comprising calculating a time at which an inventory of the product is expected to be replenished at the retail location.

19. The system of claim 18 the method further comprising automatically transmitting an alert to the mobile device informing the user of the expected inventory replenishment in response to an estimated travel time of the user to the retail location, wherein the estimated travel time is greater than the time of the expected inventory replenishment.

20. The system of claim 15, further comprising transmitting the alert when a distance between the location of the user and the retail location is below a predefined threshold.
